(19) United States
(12) Patent Application Publication
(10) Pub. No.: US 2013/0057686 A1
(43) Pub. Date: Mar. 7, 2013

(54) CROWD SOURCING PARKING MANAGEMENT USING VEHICLES AS MOBILE SENSORS

(71) Applicants: Yakup Genc, Dayton, NJ (US); Ying Zhu, Monmouth Junction, NJ (US); Mathäus Dejori, New York, NY (US); Frank Dierkes, Aachen (DE)

(72) Inventors: Yakup Genc, Dayton, NJ (US); Ying Zhu, Monmouth Junction, NJ (US); Mathäus Dejori, New York, NY (US); Frank Dierkes, Aachen (DE)

(73) Assignee: Siemens Corporation, Iselin, NJ (US)

(21) Appl. No.: 13/527,114

(22) Filed: Jun. 19, 2012

Related U.S. Application Data
(60) Provisional application No. 61/514,108, filed on Aug. 2, 2011.
(60) Provisional application No. 61/532,624, filed on Sep. 9, 2011.

(51) Int. Cl. H04N 7/18

(52) U.S. Cl. 348/148; 348/E07.085

(57) ABSTRACT

Systems and methods for monitoring parking spots are disclosed. A system includes at least one vehicle and a remote computer that are in communication with each other. A vehicle includes a camera that generates image data, a location device that generates geographic coordinates of the vehicle, a computing device that receives the image data from the camera and the geographic coordinates of the vehicle and optionally data from a laser scanner that is calibrated with the camera and is connected to a smartphone that transmits data to the remote computer. Image data generated by the camera is processed with a reference image and data from the laser scanner to determine an occupation status of the parking spot. The occupation status is transmitted by the remote computer to a second vehicle.

### CROSS-REFERENCE TO RELATED APPLICATIONS

This application claims the benefit of U.S. Provisional Application Ser. No. 61/514,108, filed Aug. 2, 2011 and of U.S. Provisional Application Ser. No. 61/532,624, filed Sep. 9, 2011, which are both incorporated herein by reference.

### BACKGROUND OF THE INVENTION

The present invention relates to methods and apparatus for a parking management system. In particular, it relates to applying image processing in collaborative mobile sensing platforms to detect vacant parking spots.

Parking spots, especially along public streets, are at a premium in large cities. Leaving free parking spots unoccupied form a source of lost revenue to a parking authority responsible for parking fee collection. Lack of knowledge about free parking spots causes drivers, who are driving through a neighborhood looking for a free parking spot, continue to waste time and fuel in search of a parking spot.

Vehicles, like buses, police cars, delivery trucks and cars driving through streets will all pass at one time an open or unoccupied parking spot during their trip. Currently there are no systems or methods that apply the capability of a plurality of moving vehicle to report an open parking spot by using imaging technology and a central system to decide the availability of an open parking spot and report it to a driver.

Accordingly, novel and improved methods and systems to detect an unoccupied parking spot, from a vehicle passing such a spot by using a camera, are required.

### SUMMARY OF THE INVENTION

In accordance with an aspect of the present invention methods and systems are provided for parking management.

In accordance with an aspect of the invention, a system to monitor a parking spot comprises a remote computer to receive data related to the parking spot and a first vehicle comprising a camera to generate image data of a parking spot, a location device that generates geographic coordinates of the vehicle, a computing device that receives the image data generated by the camera and the geographic coordinates of the vehicle and provides a time stamp and a compass heading of the camera and a communication device that transmits data related to the parking spot to the remote system. The remote computer is enabled to inform a second computing device of an occupation status of the parking spot based on a reference image characterized by the geographic coordinates of the first vehicle and the compass heading of the camera and the image data generated by the camera.

The system can further include a laser scanner range finder on the first vehicle oriented to scan the parking spot and wherein the laser scanner is calibrated with the camera. A scan generated by the laser scanner range finder indicates that an area of an image generated by the camera contains pixels representing an object taller than 50 cm located at the parking spot. Alternatively, a scan generated by the laser scanner range finder indicates that an area of an image generated by the camera contains no pixels representing an object taller than 20 cm located at the parking spot.

In accordance with another aspect of the invention, a scan generated by the laser scanner range finder is compared with a reference scan of the parking spot.

The communication device can be a smartphone. The vehicle can be a public transportation vehicle. The vehicle can also be a car.

In accordance with an aspect of the present invention, the image data generated by the camera is registered to the reference image.

The second computing device can be located on a second computing device is located on a second vehicle.

Methods corresponding to the system of the present invention are also provided.

Other aspects of the present invention are described herein.

### DESCRIPTION OF THE DRAWINGS

FIG. 1 is a diagram of a system on a vehicle in accordance with an aspect of the present invention;

FIG. 2 is a diagram of a device holder on a vehicle in accordance with an aspect of the present invention;

FIG. 3 illustrates an image of a camera calibrated with a laser scanner in accordance with an aspect of the present invention;

FIG. 4 illustrates a result of a laser scanner in accordance with an aspect of the present invention;

FIGS. 5-8 illustrate a system for calibrating a camera and a laser scanner in accordance with an aspect of the present invention;

FIG. 9 illustrates a diagram of a vehicle operating in accordance with at least one aspect of the present invention;

FIG. 10 illustrates a diagram of a vehicle operating in accordance with at least another aspect of the present invention;

FIG. 11 illustrates a system in accordance with at least an aspect of the present invention;

FIG. 12 illustrates a plurality of cars operating in accordance with at least an aspect of the present invention;

FIG. 13 illustrates a computer system for performing the steps described herein in accordance with one or more aspects of the present invention; and

FIG. 14 illustrates steps in accordance with various aspects of the present invention.

### DESCRIPTION OF A PREFERRED EMBODIMENT

Crowdsourcing is a phenomenon of collaboration, nowadays usually applying a communication network. According to Wikipedia, at <URLhttp://en.wikipedia.org/wiki/Crowdsourcing>, crowdsourcing is a process that involves outsourcing tasks to a distributed group of people. This process can occur both online and offline, and the difference between crowdsourcing and ordinary outsourcing is that a task or problem is outsourced to an undefined public rather than a specific body, such as paid employees.

In accordance with at least one aspect of the present invention, crowdsourcing is applied to vehicles that drive, preferably on a regular basis, through an area that has parking spots, preferably along or very close to a road where the vehicles are driving, by installing a camera on the vehicles so that they are directed to a side of the road where commonly parking spots are located. One purpose of such vehicles is generally to transport people or products from a source to a destination. Clearly there is a probability factor related to a time and place that an unoccupied parking spot is passed by a specific vehicle.

When sufficient vehicles carry a camera and communicate with a central system that analyzes the image data and reports an unoccupied parking spot, the approach takes on characteristics of crowdsourcing and becomes a viable approach to address parking issues.

In one embodiment, a vehicle contains a camera, directed toward or capturing within its field-of-view a part of the environment such as a road that generally contains a parking spot and a device to enable determining a location of the vehicle relative to the reported unoccupied parking spot. In one embodiment of the present invention, the camera is a part of or is connected to a mobile communication device that is connected to a network such as a mobile telephone network to transmit images from the camera to a central server.

In a further embodiment of the present invention, a geographical positioning device Global Positioning System (GPS) installed on the vehicle provides a relatively accurate position of the vehicle and the camera. The GPS device may be part of a smart phone, which also includes the camera. A parking support unit which contains at least a camera, GPS capabilities and a mobile communication device, data storage to store data and a processor to process data is thus installed on the vehicle may also be formed from individual units.

It is well known that many people have programmable smartphones. Many smartphones have built-in GPS or can connect to a GPS related navigation service. In addition, increasingly, smartphones include a digital compass. A digital compass allows the determination of an orientation of the camera without having to derive it from the GPS unit.

In one embodiment of the present invention the camera is a separate camera and not the camera of the smartphone. Also a separate GPS unit may be used. In one embodiment of the present invention a camera in or on the vehicle is combined with a laser scanner rangefinder to detect a distance between the rangefinder and a detected object and wherein pixels of the camera image are calibrated against the rangefinder.

The separate camera and the laser scanner rangefinder may be integrated in a single housing and connected to the smartphone, for instance via a Bluetooth connection or through a wired connection. The single housing may be a frame that is enabled to receive and hold the camera and the rangefinder, wherein the camera and the rangefinder have a fixed orientation and distance when located inside the frame.

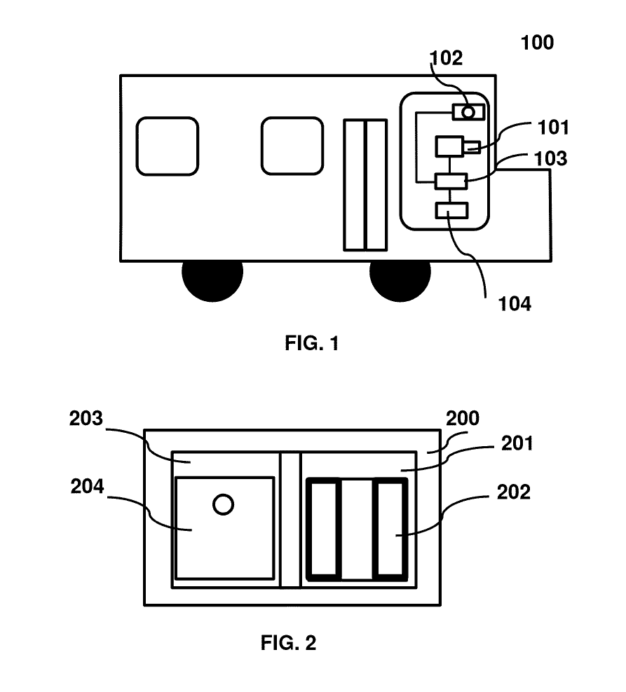

FIG. 1 illustrates a vehicle 100 with a camera 101 enabled to communicate with a smartphone 104 optionally through a processor 103. Optionally, a laser scanner 102 is also provided connected through the processor 103. The (optional) processor 103 is connected to the smartphone 104. A smartphone may be an Apple iPhone® or any other smarthphone that can receive data from a source on the vehicle. Currently, many different types of mobile computing devices connected to a wireless network are available on the market and may include a camera and a GPS unit and/or a digital compass. The mobile computing devices also contain a programmable processor. In one embodiment of the present invention a sensor box is created that has at least the camera and optionally the rangefinder, the GPS unit and the processor.

In one embodiment of the present invention, the camera, the GPS unit, the phone and the processor are all part of the mobile computing device such as a computing tablet. In that case, only the rangefinder 102 has to be connected to the mobile computing device. How the rangefinder collaborates with the camera will be described further below.

In one embodiment of the present invention, a frame or housing or equipment holder 200 is provided in which the integrated mobile computing device, such as a computing tablet 204 with camera and GPS is held in frame 203 of the housing 200 and the rangefinder 202 is held in frame or holder 201 of housing 200. The components 204 and 202 may be permanently fixed inside housing 200. In one embodiment of the present invention, at least the tablet or computing device 204 is removably held inside 203. In general, the rangefinder 202 is dedicated to the vehicle and may be permanently fixed inside 201. However, one may also hold 202 removably inside 201. When the computing device 204 with camera, GPS and phone and rangefinder 202 are in their respective holders they have a known and calibrated orientation with regard to the frame or housing 200 and thus with regard to each other. The range finder device 202 has a communication connection to device 204 to exchange data.

The scanner 202 is placed inside 201 in a vertical scanning position. Laser scanner rangefinders are known and usually scan in one plane. One application of scanners is to detect obstacles. Their range may vary. In one embodiment of the present invention a detection range of a scanner is from 5 cm to 4 meter. In another embodiment of the present invention, a detection range of a scanner is from at least 1 meter up to 5 meter. In a further embodiment of the present invention, a detection range of a scanner is from at least 1 meter up to 7 meter. In one embodiment of the present invention, a detection range of a scanner is up to 10 meter. In one embodiment of the present invention, a detection range of a scanner is greater than 10 meter.

The scanner can scan in a plane with small increments, usually somewhere between 100 and about 1000 steps with a total scan angle up to 180 to 270 degrees. The accuracy within the scanning range is generally about 1% or better and usually better than 3%. In an embodiment, the speed of a single scan is certainly less than 1 second and mostly less than 0.1 second. Driving speed in a city is commonly less than 1.5 meter/sec. This means that a parked car, even at a maximum camera travelling speed will be scanned certainly at least twice. In general, one does not need the full scan angle of 270 degrees or even of 180 degrees to measure a distance to a car to detect a car by combining the scan with an image.

At least two embodiments of the present invention will be described below: (1) crowdsourcing for parking places with a camera; and (2) crowdsourcing for parking places with a camera calibrated with a rangefinder such as a laser scanner rangefinder.

Calibration

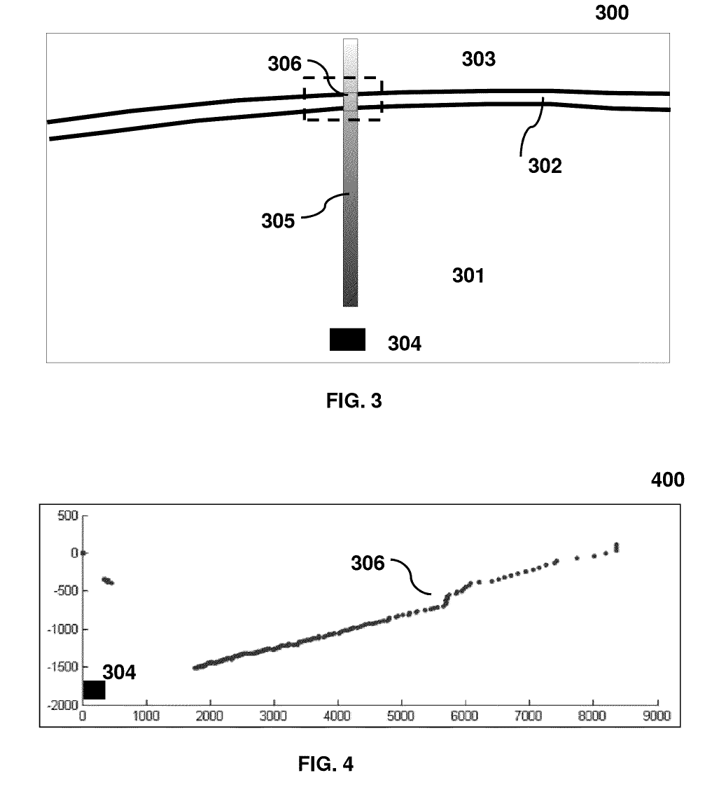

Before describing in detail the at least two embodiments of the parking spot detector, first the calibration of the camera and the rangefinder will be described. FIG. 3 shows a diagram 300 of an image that a camera sees from a car parked at spot 304 on a road surface 301 looking at a curb 302 with a height of several inches separating road 301 from grass lawn 303. From the car a laser scan is made from the car with a scanner in a vertical plane perpendicular to the curb and to the road. The scanner generates a scanning curve 400 as shown in FIG. 4. One can see from the curve that the scanner is located about 1.5 meter above the road surface and that the first reflection of the scanner is picked up from about 1.8 meter distance from the road. There are no obstacles in the road until the scanner beam hits the curb at about 5.7 meter from the scanner position. The curb rises almost vertically, which translates into a relatively constant distance to the scanner as indicated by point 306 in curve 400.

Curve 400 illustrates that not only a distance of an object can be determined by the laser scanner, but also a size of an object or a barrier. In one embodiment of the present invention, a laser scanner is used that has a resolution or capability to detect an object of at least 10 cm tall (in the scanning plane) at a distance of 7.5 meters or less. In one embodiment of the present invention, a laser scanner is used that has a resolution or capability to detect an object of at least 20 cm tall (in the scanning plane) at a distance of 8 meters or less.

The distance curve can be translated into a distance bar 305 in diagram 300. The bar 305 is darker as the distance is smaller. The bar 305 becomes lighter when the distance is greater. The curb 307 causes a fairly constant shade in bar 305, because the distance measured at the curb is fairly constant at the curb. In diagram 300 bar 305 has already been aligned with the image of the road. In accordance with an aspect of the present invention the bar 305 which reflects a distance from the scanner to an object in the environment will be calibrated against the pixels in the image of the object. Such a calibration allows an immediate determination of a distance of the camera/scanner to an object represented by a pixel of that object in an image.

A calibration of the camera to the laser scanner allows a mapping between the sensors' local coordinate systems or a mapping from the laser scanner's coordinate system to the camera's image coordinate system, respectively.

The 2D laser scanner returns the measured ranges in polar coordinates. The following equation describes the transformation to Cartesian coordinates, whereby the x-axis equals the 0° direction of the laser scanner.

$$[ \begin{matrix}{x}_{L} \\ {y}_{L}\end{matrix} ] = [ \begin{matrix}cos ϑ & 0 \\ 0 & sin ϑ\end{matrix} ] \cdot r$$

This coordinate system is the laser scanner's local coordinate system. By adding an arbitrary z-coordinate, it is mapped to three-dimensional space. A reasonable choice for z is 0, so its origin is the center of the laser scanner.

The transformation between the laser scanner and the camera local coordinate system is described by a translation t and a subsequent rotation R:

$$[ \begin{matrix}{x}_{C} \\ {y}_{C} \\ {z}_{C}\end{matrix} ] = R \cdot ( [ \begin{matrix}{x}_{L} \\ {y}_{L} \\ 0\end{matrix} ] + t )$$

Finally, to map a point from the local coordinate system to the image plane, the intrinsic matrix M_{intrinsic} of the camera is used.

$$s \cdot [ \begin{matrix}u \\ v \\ 1\end{matrix} ] = {M}_{intrinsic} \cdot [ \begin{matrix}{x}_{C} \\ {y}_{C} \\ {z}_{C}\end{matrix} ]$$

In this equation, u and v are the pixel coordinates, whereas s is the scale of the projection in the image. Below, it's assumed the knowledge of M_{intrinsic} is given. It is determined by the intrinsic calibration of the camera.

To calibrate the sensors to each other, the translation vector t and the rotation matrix R should be determined. To do this, the basic idea is to identify corresponding points in the laser scanner's local coordinate system and in the camera's image coordinate system. By solving the resulting linear equation system, t and R can be determined. In doing so, the problem is the identification of corresponding points, since the camera images do not provide any distance information whereas the distance is the main information in the laser scans.

The first approach to this problem was using a geometric pattern which is described below, which allows determining the intersection line of the pattern and the laser plane and thereby identifying certain points inside the laser scan. Additionally, the pattern is recognizable in the camera image, so the corresponding points can be identified there, too. The pattern is composed of four triangular bars on a flat wall, i.e. two pairs of two parallel bars with a well known angle between both of the pairs. By detecting the intersection points of the laser plane with the top edges of the triangular bars, the intersection line of the laser plane and the pattern is well-defined, since there is only one match for the given ratios of the distances between the intersection points. With the knowledge of these ratios, the laser plane's projection in the image (at the intersection points) is determined, too, so the corresponding points can be identified. Furthermore, this pattern allows determining the laser scanner's position in world coordinates. Due to the knowledge of the exact dimensions of the pattern not only the intersection line, but also the angle between the laser plane and the wall is well-defined.

It turned out, that this approach is not suitable for the present purpose, since it needs some effort o implement the algorithms for getting the intersection line as well as the angle between laser plane and wall. Additionally, simulating the intersection of the laser plane with the pattern at different scales showed that a pattern with easily manageable dimensions does not provide valid results.

The second idea to identify a point in the camera image as well as in the laser scan was to use a board with a small area that is recognizable in the laser scan, e.g. a mirror (which should be like a black spot for the laser scanner) or a hole in the board. Unfortunately the size of this area is problematic. Ideally, it is so small, that it is hit by only one laser beam (e.g. 4 mm at a distance of 1 m), but it turned out, that it is very time-consuming to find a position for the board or the laser, respectively, that a laser beam hits the area. On the other hand, when increasing the area's size, it gets ambiguous in the camera image as well as in the laser scan, because it is hit by multiple beams then.

The selected approach was using a very thin, circular object, similar to a bangle. It turned out that the state of the intersection of the object and the laser plane can be determined easily: If there are two hits in the laser scan, the object intersects with the laser plane. If there is only one hit, the object is tangent with the laser plane and if there is no hit, the object does not intersect with the laser plane. Since the approximate position and orientation of the laser plane is known, as well as the direction the object is moved through the laser plane, the intersection point of the object and the laser plane is well-defined in both, the camera image and the laser scan, if the object is tangent with the laser plane, i.e. if there is only one hit in the laser scan.

The translation and rotation is determined by six parameters, i.e. at least six corresponding points are necessary. Since the sensors' measurements as well as the identification of the intersection point in the sensors' output is not exact, a greater number of corresponding points is used to reduce the error.

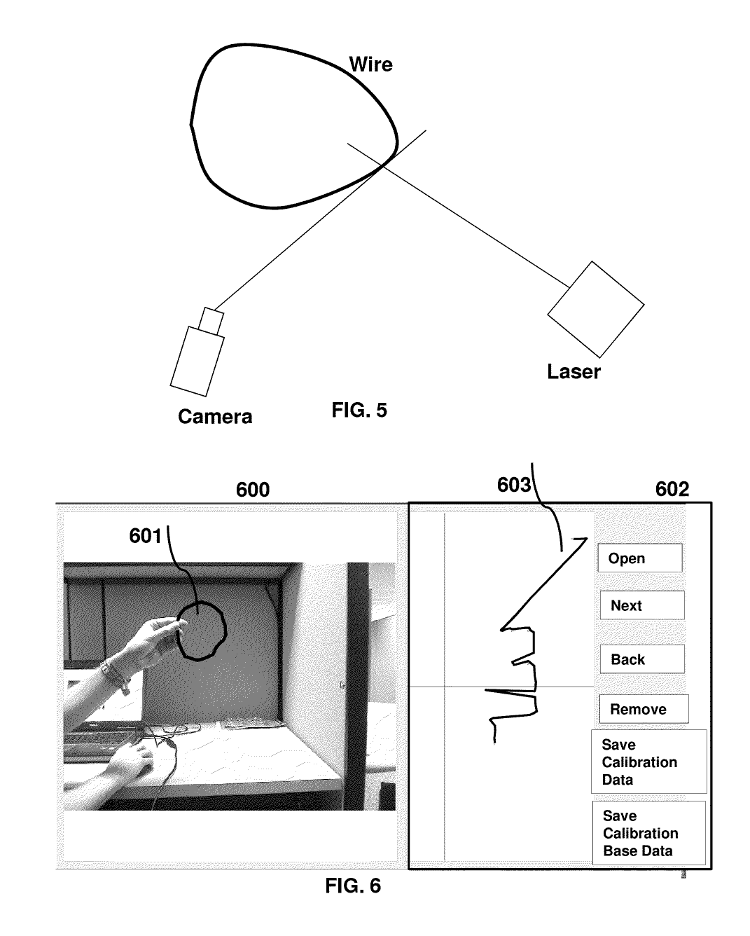

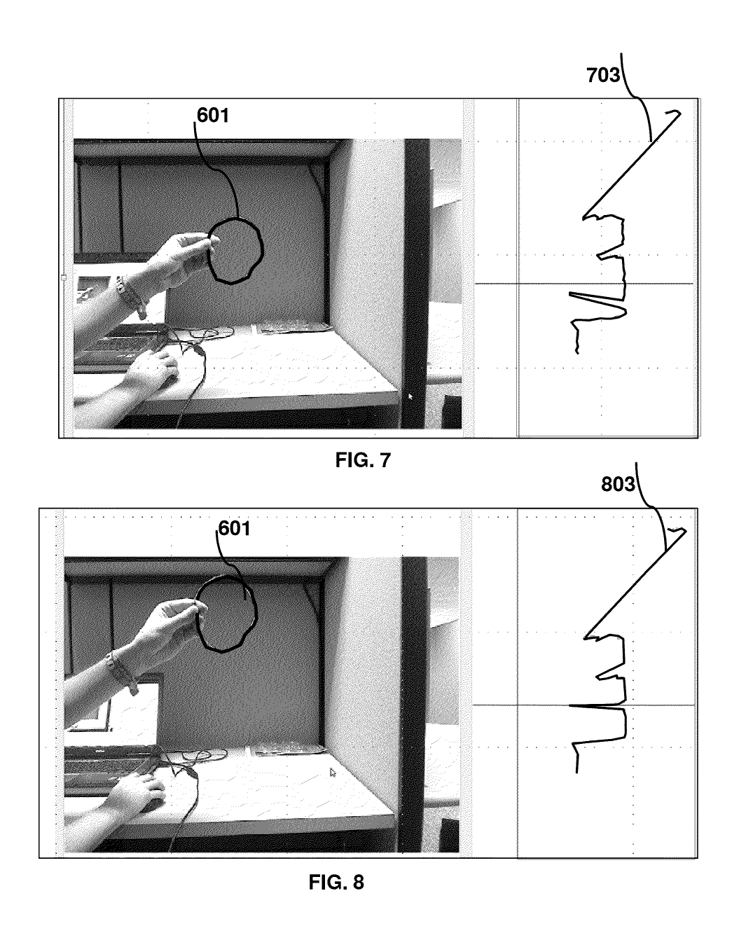

FIG. 5 illustrates a set-up for the calibration using a wire a camera and a laser scanner. FIG. 6 shows an image 600 of a person holding a wire 601 and of a screen 602 which displays the scanning curve 603. FIG. 7 shows the same wire 601 held at a different position and the corresponding scan curve 703. FIG. 8 shows the same wire 601 held at a different position and the corresponding scan curve 803.

Parking Management

In one embodiment of the present invention a database is created with images of parking spots along a road or at locations within sight of a camera on a vehicle on the road. The images are preferably taken with no cars parked at the parking spot. Furthermore, images are taken with a known orientation and location of the camera and the geographical location of the parking spot are known. These images may be called baseline images. The baseline images are stored in a database and are associated with the geographical location of the parking spot and with a location and an orientation of the camera. In one embodiment of the present invention, the baseline images are stored in a central location. In another embodiment of the present invention these baseline images may be stored on a database on a vehicle. In one embodiment of the present invention a series of baseline images is provided to a vehicle related to a road where the vehicle is driving.

The approach is that a vehicle with a camera and possible a laser scanner, as provided herein in accordance with various aspects of the present invention, records images of potential parking spots while it is driving along the road. The GPS capabilities of a system on the vehicle provide a geographical stamp and if so desired an orientation of the camera as it collects images.

This allows a processor to compare the just recorded images with related baseline images which are stored in a database. For instance, one may select a baseline image that best approximates the location and orientation of the camera of the just recorded image. A system in one embodiment registers the images and subtracts the baseline image from the just recorded image in the registered mode. If no substantial difference exists between the subtracted images then the parking spot is likely unoccupied. However, if in the subtracted images a residue remains in the parking location, then most likely the parking place is occupied.

One can use one of many image processing techniques to compare images. For instance, instead of comparing full images one can extract edges in the image to highlight certain features in the image. This may include curbs, trees, lamp posts, parking meters, building features such as doors and windows and anything else that will generate an edge in an image. An edge extraction image is smaller in data size than a full image and can be stored and processed faster and requiring less data processing. Based on the comparison of a recent image with a baseline image or derived images there from a decision can be made if a parking spot is occupied.

In one embodiment of the present invention, the baseline images are provided with a laser scan which provided a distance of the camera/scanner to the closest object. There is generally no parked car in the baseline image. Accordingly, in the baseline image, where a parked car would have been, a substantial free and unobstructed distance will exist, for instance of at least 3 to 4 meters. A minimum free distance, for instance detected with a laser scanner, may be recorded and associated with the baseline image, including the position and if so desired the orientation of the camera. The baseline image can be marked as being associated with an occupied or an unoccupied parking spot.

In one embodiment of the present invention, a baseline image of an unoccupied parking spot is generated and stored, and provided with a GPS stamp and if desired a camera orientation. In a further embodiment of the present invention, a baseline distance indicator is generated, which may be a laser scanner rangefinder scan which scans the parking spot and is associated with the position of the camera. In further embodiment the distance scan is analyzed by a processor and an uninterrupted distance (uninterrupted by a sizable object) is determined. In a next step a distance to a first sizable object may also be determined. This may include an estimate of a size of an object, or a minimum size. For instance, a distance scan may determine a wall that is higher than 1 meter at a distance of at least 6 meters from the scanner. The minimum free distance may be included as an indicator or label of the parking spot, together with for instance geographical coordinates. The camera and scanner for generating the baseline data form preferably a calibrated pair. The preferred area for detecting a car in an image can be marked an analyzed using the distance data.

In one embodiment of the present invention, a parking spot is marked as unoccupied if a system comprising a laser scanner range finder calibrated with a camera does not find an object with a size taller than 10 inches in the parking spot. In one embodiment of the present invention a parking spot is marked as unoccupied if a system comprising a laser scanner range finder calibrated with a camera does not find an object with a size taller than 20 cm in the parking spot. In one embodiment of the present invention, a parking spot is marked as unoccupied if a system comprising a laser scanner range finder calibrated with a camera does not find an object with a size taller than 50 cm in the parking spot. In one embodiment of the present invention, a parking spot is marked as unoccupied if a system comprising a laser scanner range finder calibrated with a camera does not find an object with a size taller than 1 meter in the parking spot.

In one embodiment of the present invention, only a baseline image (and not a distance scan) is generated from a parking spot.

During operation a vehicle is provided with a parking place detection system that includes a camera, GPS or similar capabilities, a processor and a wireless communication device to send and receive data. The basic location of the camera (height, relative to the road, distance relative to a side of the vehicle and orientation relative to driving direction, location relative to GPS and the like) may be determined and entered into the processor. The system is at least provided with enough data to determine the location and thus moment when a picture has to be taken by the camera to capture the parking spot.

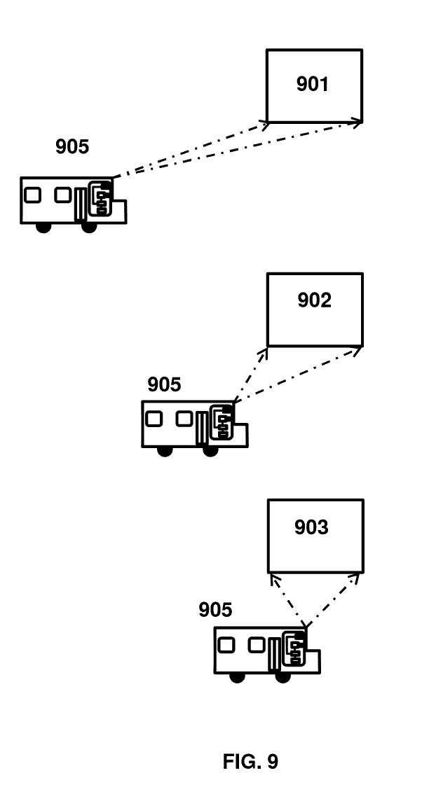

In one embodiment of the present invention, the orientation of the camera relative to the driving direction on the vehicle is about the same as the camera used to take the baseline or reference image. This can make image registration easier and/or faster. In one embodiment of the present invention the camera taking baseline images takes a series of baseline images of a specific parking spot from different angles relative to the parking spot. This is illustrated in FIG. 9 wherein a vehicle 905 drives on a road to record baseline images of a parking spot and records at least three baseline images 901, 902 and 903. The images can be taken with a special camera or with three different cameras, each positioned in a different orientation during a baseline run.

The advantage of a dedicated baseline run for parking management application is that it can be combined with a laser scan and different camera angles can be used. However, such a dedicated baseline run is not really required as one can apply image processing techniques to register already known images of a road side with current images taken from a moving vehicle. There are different services that have collected and continue to collect road-side images. Among those are Google Street View from Google, Inc. headquartered in Mountain View, Calif.; Mapjack International Limited, headquartered in Hong Kong; and Streetside from Microsoft Corporation headquartered in Redmond, Wash.

Images from these services can usually be obtained by providing latitude and longitude of the location of the camera and a compass orientation of the camera. Because the actual camera position may be slightly different from the requested location a delivered image may “snap” to the actual location and the actual coordinates will be provided.

A vehicle with a GPS unit and a camera when driving along a parking spot will take an image of a spot. The GPS unit determines the location of the camera and possibly its compass orientation. The GPS unit either on-board the vehicle or in a central system that receives the image data of the moving vehicle associates the image with a parking spot which is indicated on a parking map. Such maps provide the actual location of the parking sports, including parking meter locations, which can function as a landmark. Such GPS associated parking maps will prevent the system from identifying an open spot where it is not allowed to park as a valid open parking spot.

A moving vehicle with a camera and a GPS unit can calibrate the orientation of the camera by generating images in the neighborhood of landmarks. For instance, driving at the right hand side of a road and approaching a light pole a series of images can be taken and the light pole can be detected from the picture. By knowing the location of the light pole, the location of the vehicle/GPS unit and/or the camera and having an image of the light pole in a known position on the camera (center for instance) one can determine the compass direction of the camera.

In one embodiment of the present invention, the camera on the vehicle takes constant images of the road side, for instance in a video mode. The processor connected to the camera can also instruct the camera to take images, only when it passes valid parking locations.

While it is advantageous to have baseline images taken from the same direction as the current images, it is not required to do so. Image registration techniques allow for images capturing the same area but from different angles to be transformed so the important feature substantially match. As discussed above, it may be beneficial to first extract image features by edge or corner detection and transform the extracted features in the image for instance to find a match, before proceeding with additional steps. The reason for providing intermediate steps is the requirement for bandwidth to transmit large amounts of image data in an urban area which may be congested in wireless communication traffic.

In one embodiment of the present invention, a map of the road with identified parking spots with coordinates is available to a processor on the vehicle, for instance as a stored map on a data storage device on the vehicle. Such maps may for instance be stored on a GPS based navigation system. However, it is fully contemplated that geographical parking spot information may also be obtained from outside the vehicle via a wireless network from a database.

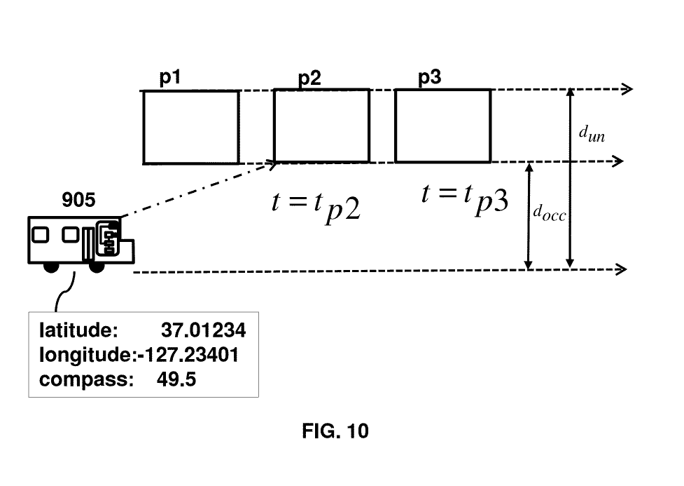

FIG. 10 illustrates one embodiment of the present invention to determine a moment related to a parking spot. The vehicle 905 which has a GPS system and has a camera with an orientation fixed to the driving direction is close to parking spots p1, p2 and p3. Based on geographical and map information the system has calculated that at the present latitude and longitude (usually processed in decimal form, and the example in FIG. 10 is in the Pacific Ocean) and with the orientation or heading of the camera it will take images of the parking spot p2 starting at time t=tₚ₂ and for a following period of Δtₚ₂ seconds. From moment t=tₚ₃ an image can be taken from parking spot p3.

In one embodiment of the present invention, a video clip of a stretch of road is received with the geographical data, compass heading and the time stamp. Based on a parking map and with the geographical and time stamp a system can determine which frames in the video relate to a certain parking spot.

Accordingly, a vehicle has been provided in accordance with one or more aspects of the present invention that can perform the following steps:

a. determine a geographical location and a compass orientation of a digital camera on a vehicle;

b. retrieve an image (called a reference or baseline image) from a database based on the geographical location and orientation of the camera;

c. take an image with the camera at the geographical location and with the orientation of the camera;

d. compare the reference or baseline image with the taken image;

e. decide if an object occupies the parking spot; and

f. share data related to the parking spot obtained by a system on the vehicle via a mobile network with a remote system which may be a central system.

Where image processing takes place and which system decides if the parking place is unoccupied depends on the configuration of the system and the data transmission requirements. In one embodiment of the present invention, all the processing and data access takes places on or from the vehicle in the processor 103 and a transmitter on the vehicle only transmits data to the central or remote system related to the parking place being occupied or not, including a geographical stamp and a time stamp.

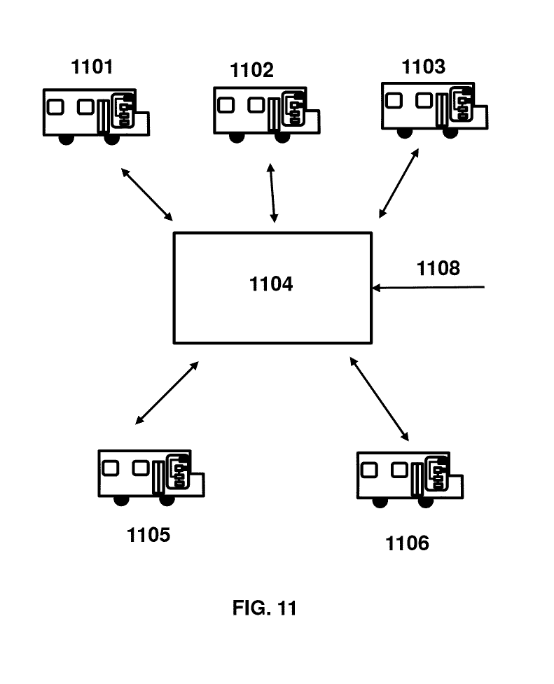

At the other end of the spectrum, the system on the vehicle generates an image with a geographical and time stamp and transmits it to the remote system (1104 in FIG. 11). The image therein may be a processed image such as based on extracted edges and or corners. The remote system is enabled to access data bases and does image registration and makes the decision if a parking spot is occupied or not based on the received image, further processed by the remote system.

In accordance with various aspects of the present invention either the system on the vehicle or the remote system performs the intermediate steps for determining if a parking spot is occupied, wherein of course the current image has to be taken from the vehicle and the remote system has to receive data related to the parking spot being occupied or not.

In addition to taking an image by the camera on the vehicle, the vehicle in accordance with an aspect of the present invention is provided with a laser scanner rangefinder that is calibrated with the camera on the vehicle. The system on the vehicle generates the laser scan related to the parking spot. The trigger to start a laser scan for a particular may be the same or similar as for the camera, but adjusted for the orientation of the scanner. The scanner in one embodiment of the present invention is activated when positioned to scan the parking spot. The scanner in one embodiment of the present invention operates on a continuous or semi-continuous basis and the scans for a particular spot are found based on the geographical data and time stamps and the parking map.

Based on the calibrated laser scan, a system can determine if a space contained an object within a certain distance. Based on the geographical data generated by the GPS and the parking map data, one can determine that the vehicle is driving at a distance of dᵤₙ from the curb and d_{occ} from the edge of the parking spot, as illustrated in FIG. 10. Based on the calibration, the system decide the distance of an object from the scanner. For instance, if no sizable object is detected within a distance dᵤₙ, then the parking spot is unoccupied. If a sizable object, for instance higher than 5 inches, or higher than a foot, is detected within a distance <dᵤₙ, the system decides that the spot is not free.

An image subtraction that leaves a residue in an area where a car would be if it was parked at a parking spot and a laser scan that indicates an object provide strong evidence that a parking spot is occupied. Also an absence of a residue in an image subtraction and an absence of a sizable object in a laser scan are strong proof that the parking space is unoccupied.

As discussed above, the system can work only by way of images, only by laser scans or by a combination of both. In one embodiment of the present invention, a portable and mobile computing device with GPS and imaging capabilities is placed into a frame or holder attached to a car. The camera orientation is calibrated by images of known landmarks and takes images provided with geographical and time stamps for a remote system and transmitted via a mobile network to which the phone is connected. In a further embodiment of the present invention, the frame also contains a laser scanner which will be calibrated with the camera.

In one embodiment of the present invention, a camera-based sensor box containing a processor, a camera and a laser scanner is created which is attached to a car and is synchronized with a smart phone in the car. The sensor box may be composed of off-the-shelf components but can also be custom made, such as embedded in windshield or other parts of the car. These boxes may be made available to participating drivers by for instance an authority or organization such as a parking authority. The pay-off or benefit to participating drivers may be receiving electronic updates, for instance on the smart phone, of available un-occupied parking spots. Other benefits, including money payment, may be provided for participating. In one embodiment of the present invention, certain parking spots are dedicated to participants in a program wherein vehicles act as sensor platforms.

In one embodiment of the present invention, outward looking cameras are an embedded feature in vehicles that are allowed to drive in areas such as cities with congested traffic situations.

In one embodiment of the present invention, complete sensor boxes are installed on cars that regularly and fairly often drive through an area with parking spots. Such vehicles may be buses, delivery trucks, police cars, mail delivery trucks, taxis or any other private, public or utility vehicle and the like. If uncertainty exists about a parking spot and no vehicle with a sensor box is in the area of the parking spot that will drive past, a car with at least a camera that is on a course to pass the specific spot may be probed for images or may be instructed to take an image of the particular spot.

FIG. 11 illustrates in diagram a system as provided herein in accordance with various aspects of the present invention. Vehicles 1101, 1102 and 1103 are provided with a camera and/or a laser scanner or a sensor box and are in contact via a mobile network with a remote or central system 1104. System 1104 collects data from these sensor platform vehicles. The decision if a parking spot is unoccupied may be taken by the systems on the vehicles or by the central system 1104. The system 1104 may receive additional external data 1108 to come to a decision.

The decision if a parking spot is unoccupied is administered by 1104, which via a mobile connection informs vehicles 1105 and 1106 about available unoccupied parking spots. For that purpose, vehicles 1105 and 1106 must have registered as participants and must have placed a request for a parking spot. System 1104 may assign an unoccupied parking spot to a requesting vehicle. One rule of a parking system may be that designated parking spots can only be occupied by participating vehicles that have requested for an unoccupied parking spot and have been assigned an available designated parking spot.

In one embodiment of the present invention, parking meters are also connected to the central or remote system. A parking meter can inform the system if the meter is still running for a parking spot or if the meter has run out. If the meter is no longer running and meter rules are in effect then there should not be a car parked at that particular spot. The system as provided herein can be applied to determine if a vehicle is present while a meter is not running. The system can thus be applied to enforce parking rules.

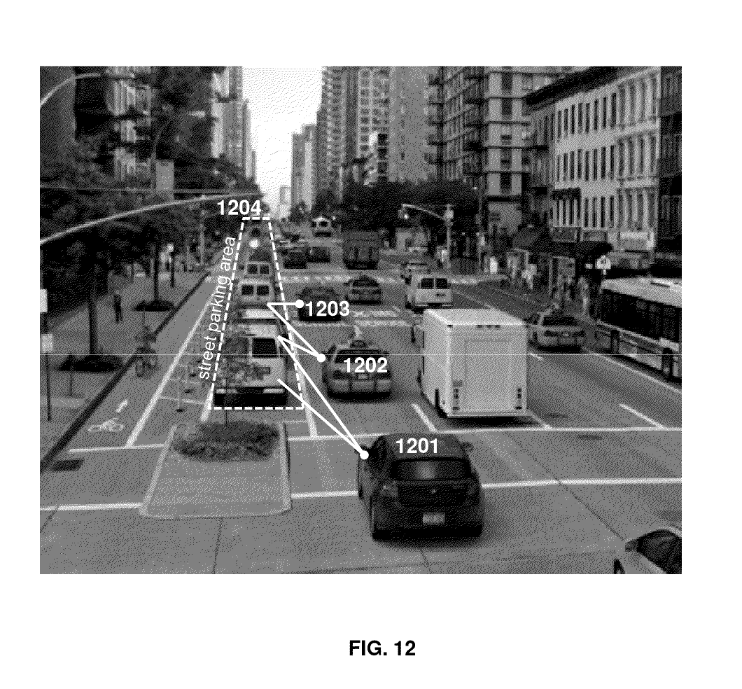

FIG. 12 further illustrates the system. Cars 1201, 1202 and 1203 are sensor platforms. They monitor parking lots defined by area 1204.

The advantages of a system with mobile sensor platforms include: Ubiquitous monitoring of parking resources; lower maintenance and infrastructure cost than current solutions; increase revenue through better utilization; cut carbon emissions by reducing search time; improved monitoring and enforcement of parking violations (knowing when a spot is empty); and incentive for drivers to participate through value added services (e.g. parking finder).

A vehicle that participates in the monitoring system has at least one camera. In one embodiment of the present invention a vehicle is provided with at least two cameras to monitor parking spots. For instance a bus or a light rail vehicle has enough space to accommodate more than one camera.

System Description

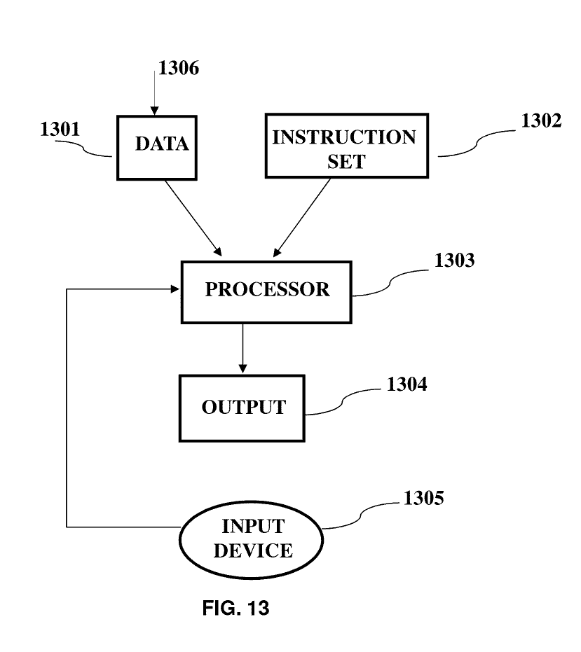

The image recording, image analysis, laser scan creation and other aspects of the present invention can be executed by a system as shown in FIG. 13. The system of FIG. 13 can be implemented in the vehicles to provide necessary processing, including video processing. The system of FIG. 13 can also be implemented in the remote or central system. The system is provided with data 1301 which can be image data and GPS data. Image data may be provided on an input 1306. Data such as image data may be provided by an input device 1205, which in one embodiment is a camera. Such data may be provided on for instance a continuous basis. Other input devices are also contemplated and may include but are not limited to a speed sensor, a navigation system, a GPS system, a communication device, and a computing system having a processor. An instruction set or program 1302 executing the methods of the present invention is stored on a memory and is provided to the processor 1303, which executes the instructions of 1302 to process the data 1301. An image or a message or any other signal resulting from the processor can be outputted on a device 1304. Such a device for instance is a communication device such as a wireless communication device, to provide data to a network which connects to another system. The processor can be dedicated hardware. However, the processor can also be a CPU or any other computing device that can execute the instructions of 1302. Accordingly the system as shown in FIG. 13 provides a system for mobile sensing and data processing and communication of data related to parking management and is enabled to execute the steps of the methods as provided herein as an aspect of the present invention. The processing system can be in the vehicle 100 or in the remote central system 1104 or both.

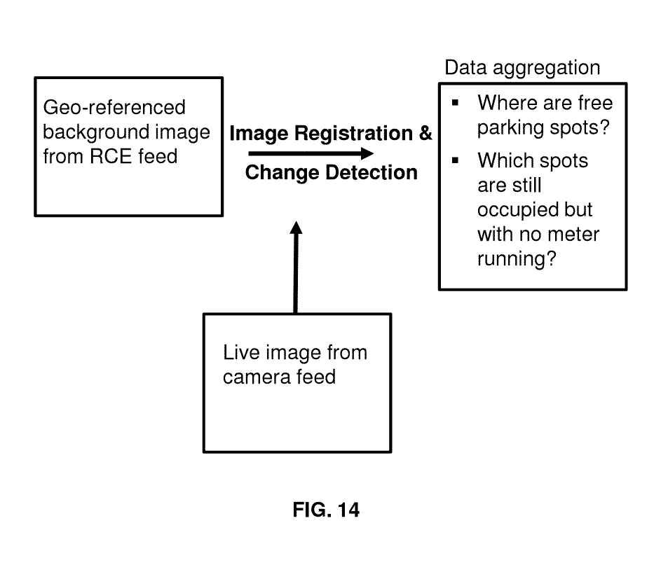

FIG. 14 illustrates some of the steps and a flow of information in accordance with one or more aspects of the present invention. Geo-referenced background or baseline images are retrieved and are processed with live images from vehicle based camera feed by image registration and change detection. Included in the data may be laser scan data of a laser scanner calibrated with a camera. In a central computer data is stored that indicates which parking spots are free and at which parking spots a vehicle is located with an expired parking meter. The central computer may send this data to a computing device on a vehicle of which the driver is looking for an empty and available parking spot. The central computer may also send data to a computer of a parking authority to enforce parking rules.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims appended hereto.

1. A system to monitor a parking spot, comprising:
a remote computer to receive data related to the parking spot;
a first vehicle comprising:
a camera to generate image data of a parking spot;
a location device that generates geographic coordinates of the vehicle;
a computing device that receives the image data generated by the camera and the geographic coordinates of the vehicle and provides a time stamp and a compass heading of the camera; and
a communication device that transmits data related to the parking spot to the remote system; and wherein
the remote computer is enabled to inform a second computing device of an occupation status of the parking spot based on a reference image characterized by the geographic coordinates of the first vehicle and the compass heading of the camera and the image data generated by the camera.

2. The system of claim 1, further comprising:
a laser scanner range finder on the first vehicle oriented to scan the parking spot and wherein the laser scanner is calibrated with the camera.

3. The system of claim 2, wherein a scan generated by the laser scanner range finder indicates that an area of an image generated by the camera contains pixels representing an object taller than 50 cm located at the parking spot.

4. The system of claim 2, wherein a scan generated by the laser scanner range finder indicates that an area of an image generated by the camera contains no pixels representing an object taller than 20 cm located at the parking spot.

5. The system of claim 2, wherein a scan generated by the laser scanner range finder is compared with a reference scan of the parking spot.

6. The system of claim 1, wherein the communication device is a smartphone.

7. The system of claim 1, wherein the vehicle is a public transportation vehicle.

8. The system of claim 1, wherein the vehicle is a car.

9. The system of claim 1, wherein the image data generated by the camera is registered to the reference image.

10. The system of claim 1, wherein the second computing device is located on a second vehicle.

11. A method to monitor a parking spot, comprising:
a first vehicle sending data related to the parking spot by a communication device on the vehicle to a remote computer, the data being sent by the communication device is based on data collected by a first computing device located on the vehicle from a camera to generate image data of the parking spot and a location device that generates geographic coordinates of the vehicle, and
the remote computer sending data related to an occupation status of the parking spot based on the data received from the first vehicle to a second computing device.

12. The method of claim 11, further comprising:
a laser scanner range finder on the first vehicle generating a scan of the parking spot, wherein the laser scanner is calibrated with the camera.

13. The method of claim 11, wherein the image data generated by the camera of the parking spot is processed with a reference image of the parking spot.

14. The method of claim 12, wherein a scan generated by the laser scanner range finder indicates that an area of an image generated by the camera contains pixels representing an object taller than 50 cm located at the parking spot.

15. The method of claim 12, wherein a scan generated by the laser scanner range finder indicates that an area of an image generated by the camera contains no pixels representing an object taller than 20 cm located at the parking spot.

16. The method of claim 11, wherein the communication device is a smartphone.

17. The method of claim 11, wherein the vehicle is a public transportation vehicle.

18. The method of claim 11, wherein the vehicle is a car.

19. The method of claim 11, wherein the image data generated by the camera is registered to a reference image.

20. The method of claim 11, wherein the second computing device is located on a second vehicle.
